(19) United States
(12) Patent Application Publication
(10) Pub. No.: US 2022/0082124 A1
(43) Pub. Date: Mar. 17, 2022

(54) Tie-Down Stake for Yard Ornaments

(71) Applicant: Jeffery J. Kacines, Allen, TX (US)

(72) Inventor: Jeffery J. Kacines, Allen, TX (US)

(21) Appl. No.: 17/019,213

(22) Filed: Sep. 12, 2020

(51) Int. Cl. F16B 35/06; F16B 45/00

(52) U.S. Cl. CPC F16B 35/06; F16B 45/00

(57) ABSTRACT

A tie-down stake for anchoring objects to the ground. The tie-down stake is constructed with an eye lag screw and with a flat washer welded below the eye of the lag screw. The flat washer functions as a stop. A swivel arm has a hoop through which the threaded shaft of the eye lag screw is inserted. The swivel arm has a portion that extends laterally outwardly and a terminal end that extends downwardly. When the eye lag screw is screwed into the ground, a tether cord of the object can be engaged around the swivel arm, and when the terminal end of the arm is embedded in the ground, the tether cord is captured between the swivel arm and the ground.

### TECHNICAL FIELD OF THE INVENTION

The present invention relates in general to stakes and anchor mechanisms, and more particularly to methods and apparatus for anchoring yard ornaments to prevent inadvertent removal or displacement.

### BACKGROUND OF THE INVENTION

Inflatable yard ornaments are popular to provide decorations that celebrate different holidays of the year, and other events such as birthdays, anniversaries, patriotic, etc. For example, during the Easter holiday, inflatable rabbits can decorate one's yard. During the Christmas holiday, there are inflatable Santa Claus figures, sleighs, reindeer, candles, nativity scenes, etc., that are available to decorate a yard or other area. Some inflatable structures are illustrated in U.S. Pat. Nos. D850,976; D372,205 and D334,707.

Other inflatable items include toys and recreational structures which are employed to entertain children. These include inflatable bouncers and water slides, many of which require a constant air pressure stream to maintain the structures inflated. While not inflatable, camping tents require staking to maintain the structure in the desired site.

A common problem with inflatable and other structures is that such items can be easily displaced by the wind unless securely anchored to the ground, a tree or building structure. If the inflatable structure is not too large, it can be weighted at its bottom with sand or other heavy material to lower the center of gravity and maintain the item upright and in place. Larger inflatable structures can be constructed with material loops around the peripheral bottom area. Individual stakes can be used by pounding the same into the ground so that a part of the stake secures the loop to the ground. This is a common practice, and often commercially available tent stakes are used to anchor the loops of the inflatable structure to the ground. A similar anchor technique is illustrated in U.S. Pat. No. 4,837,958.

The use of tent stakes, or similar stakes, is effective to anchor the inflatable structure, but often the ground is too hard to pound the stake into the ground, and/or the stake becomes firmly embedded in the ground and cannot be easily removed.

Another commonly-used stake is known as a dog tie-out stake, which is used to tether a dog around a screw-type stake that is screwed into the ground. This type of stake has a very course helical rod that is screwed into the ground. A closed ring encircling the top of the helical stake is used as an anchor point for a leash, cable or chain. A similar type of dog tie-out stake is constructed with a straight rod and an auger at the bottom thereof to auger the stake into the ground. Such type of dog tie-out stake is illustrated in U.S. Pat. No. D632,442.

It can be seen from the foregoing that there is a need for an anchor arrangement which is threaded so that it can be screwed into the ground, whether hard or not, and which can be easily removed by simply reversing the operation. A further need exists for an anchor stake that can be retracted somewhat so as to release the loop of the inflatable structure, without entirely removing the threaded stake from the ground. A further need exists for an anchor stake which captures the loop of an inflatable object between an arm and the ground, so that once the arm is retracted somewhat, the loop can be removed.

### SUMMARY OF THE INVENTION

In accordance with the principles and concepts of the invention, disclosed is an anchor arrangement in which a threaded stake has an upper eye part which can function as an anchor mechanism as well as a means to screw the device into the ground. The anchor device includes a swivel arm that extends from the threaded stake to capture a loop or another portion of an inflatable object between the ground and the arm. Both the eye part and the arm can function as different anchor points to secure an object and prevent inadvertent movement.

In accordance with an embodiment of the invention, disclosed is an eye lag screw that has an eye part at the top portion, and a threaded part at the bottom. The swivel arm has a hoop through which the threaded part of the eye lag screw is inserted. The arm has a further part that extends outwardly and downwardly from the eye lag screw. When the eye lag screw is screwed into the ground, the loop of a tether is placed around the arm. When the downwardly depending part of the arm becomes embedded in the ground, the loop of the tether becomes captured between the arm and the ground.

According to a feature of the invention, the eye lag screw is equipped with a stop that prevents further upward movement of the arm hoop as the eye lag screw is fully screwed into the ground.

According to another feature of the invention, the eye of the eye lag screw provides a first anchor point for a tether cord, and the arm provides a second anchor point for anchoring a tether cord, or the like.

According to another feature of the invention, the arm can be constructed with different shapes to adapt the tie-down stake to different applications.

In accordance with an embodiment of the invention, disclosed is a tie-down stake that includes a threaded shaft having a bottom end that is pointed, and the threaded shaft has a top end constructed with an eye. Further included is an arm that has a hoop through which the threaded shaft passes. The arm further includes a capture member that includes a portion that extends downwardly so that when the threaded shaft is screwed into the ground, a bottom terminal end of the capture member is embedded in the ground, thus capturing a tether cord between the capture member and the ground. The tether can be removed from the capture member without entirely removing the threaded shaft from the ground.

In accordance with a further embodiment of the invention, disclosed is a tie-down stake that includes an eye lag screw that has a threaded shaft with a bottom end that is pointed. The eye lag screw has a top end constructed with an eye. The eye lag screw has a stop welded to the shaft having threads. A swivel arm has a hoop through which the threaded shaft passes until stopped by the stop. The arm is thus adapted for remaining non-rotatable while the eye lag screw is screwed into the ground. The arm further includes a capture member that includes a portion that extends radially outwardly from the hoop and then downwardly so that when the eye lag screw is screwed into the ground, a bottom terminal end of the capture member is embedded in the ground, and a tether cord can be captured between the capture member and the ground. The tether can be removed from the capture member without entirely removing the threaded shaft from the ground.

According to yet another embodiment of the invention, disclosed is a method of using a tie-down stake to anchor objects. The method includes threading a hoop of an arm over a threaded shaft of an eye lag screw so that a capture portion of the arm extends laterally outwardly and a terminal end of the arm extends downwardly. The eye lag screw is screwed partially into the ground without rotating the arm. The loop of the object to be anchored is engaged around the arm. The eye lag screw is further screwed into the ground until the terminal end of the arm is embedded in the ground, whereby the tether is captured between the arm and the ground.

### BRIEF DESCRIPTION OF THE DRAWINGS

Further features and advantages will become apparent from the following and more particular description of the preferred and other embodiments of the invention, as illustrated in the accompanying drawings in which like reference characters generally refer to the same parts, functions or elements throughout the views, and in which:

FIG. 1 is a side view of a tie-down stake constructed according to the invention;

FIG. 2 is a side view of the tie-down stake of FIG. 1 installed in the ground;

FIG. 3 is a side view of the tie-down stake with an arm thereof capturing a leg portion of an inflatable ornament to the ground;

FIG. 4 is a side view of the tie-down stake providing an anchor point to the eye of a lag screw;

FIG. 5 is a side view of the tie-down stake providing two anchor points for one or more inflatable objects;

FIGS. 6a and 6b are respective side and top views of the arm portion of the tie-down stake constructed according to an embodiment of the invention;

FIG. 7 is a side view of an arm portion of the tie-down stake constructed according to another embodiment of the invention; and

FIG. 8 is a side view of an arm portion of the tie-down stake constructed according to yet another embodiment of the invention.

### DETAILED DESCRIPTION OF THE INVENTION

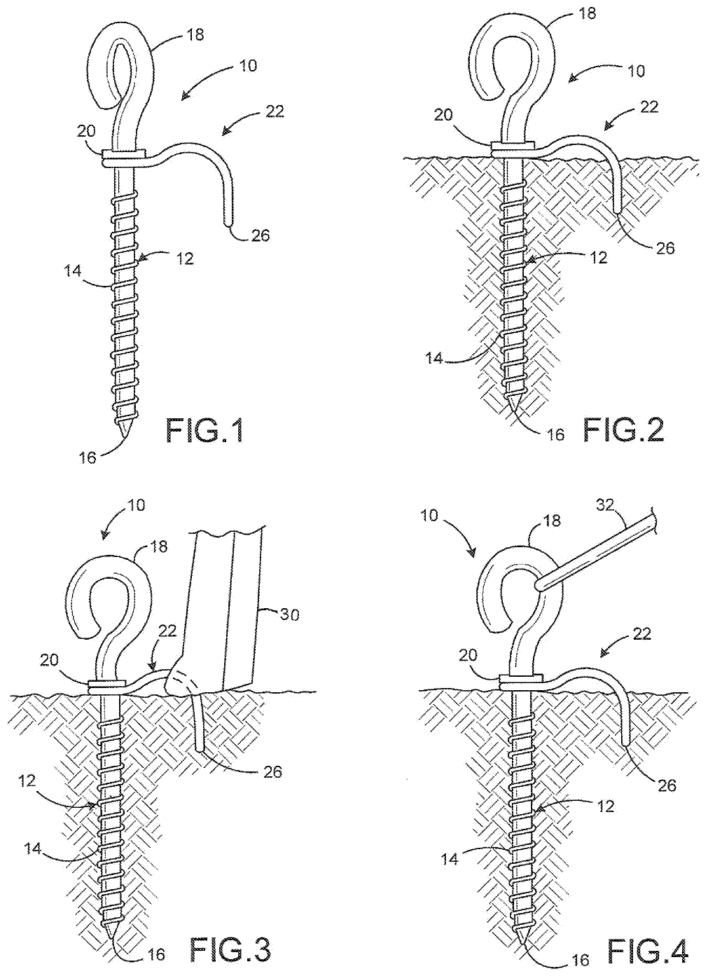

With reference to FIG. 1 of the drawings, there is illustrated a tie-down stake 10 for anchoring objects and ornaments to the ground. The tie-down stake 10 includes a conventional eye lag screw 12 of the type that has threads 14 and a pointed bottom end 16. Such type of eye lag screw is adapted for screwing into wood for anchoring objects thereto. The eye lag screw 12 is also of the type that has at its top end a circular eye 18. Other eye lag screws having a non-circular eye or hook can be used with equal effectiveness. The eye 18 may or may not have an end that is welded to the main threaded shaft. In the preferred embodiment, the eye lag screw is constructed with a diameter of about 0.275 inch, and a threaded shaft having a length between about 3 inches and 6 inches. However, the eye lag screw 12 can be constructed with many other dimensions and shapes for adaption to different ground textures and different applications.

The tie-down stake 10 is constructed using the eye lag screw 12 with a stop 20 in the form of a flat washer spot welded at a location between the bottom of the eye 18 and the upper end of the threads 14. The washer 20 can be of a standard type having a hole dimension of about 0.3 inch. The washer stop 20 can be threaded onto the threads of the eye lag screw 12 from the bottom upwardly toward the eye 18, or, if possible, onto the end of the eye 18 and around the eye 18 down onto the shank of the threaded shaft 14. In some application, the stop 20 can be eliminated entirely.

In accordance with the features of the invention, the tie-down stake 10 is constructed with a swivel arm 22 that has a circular hoop 24 through which the threaded shaft 14 of the eye lag screw 12 is inserted until stopped by the washer 20. With this arrangement, the arm 22 can swivel around the eye lag screw 12 on the upper non-threaded portion of the shank of the eye lag screw 12. In an embodiment of the invention, the top portion (0.5 inch) of the threaded shaft 14 is not threaded to thereby facilitate rotation of the hoop 24 of the arm 22 thereon. Accordingly, as the eye lag screw 12 is screwed into the ground, the swivel arm 22 can remain stationary. The arm 22, constructed in accordance with the preferred embodiment of the invention, is illustrated in more detail in FIGS. 6a and 6b. The arm 22 is constructed as a one-piece article with a steel rod or wire having a diameter of about 0.1 inch. The rod material of the arm 22 has sufficient rigidity so that it does not easily bend during use. Steel can be hardened or made more rigid by techniques well known in the art. The end of the hoop can be welded to the arm so that the hoop is closed.

The rod material of the arm 22 extends from the hoop 24 radially outwardly and then gently or gradually downwardly to a bottom terminal end 26. In other words, the transition of the arm 22 from the laterally outwardly portion to the linear downward portion is generally circular. The bottom end 26 can be blunt or more preferably pointed so as to more easily pierce the ground. The dimension of the arm 22 from the top of the curved section to the bottom end 26 is about 1.1 inches. The arm 22 extends laterally away from the threaded part 14 about 1.1 inch.

The anchoring of the tie-down stake 10 is illustrated in FIG. 2. During installation of the tie-down stake 10, the hoop 24 of the arm 22 is slid over the threaded rod 14 upwardly until stopped by the washer stop 20. Then, the eye lag screw 12 is screwed into the ground by pressing the pointed end 16 into the soil and then turning the eye lag screw 12 using the eye 18. Depending on the firmness of the ground, the eye 18 can be rotated by the user's fingers, or by using a screw driver that is extended through the eye 18, and then by rotating the screw driver. Pliers and other tools can be used to assist in rotating the eye lag screw 12 into the ground. In practice, it has been found that the threads of the eye lag screw 12, which are normally intended for anchoring in wood, are well adapted for anchoring in rocky ground areas, as well as soil. When the ground is hard, the top of the arm 22 can be tapped with a hammer as the eye lag screw 12 is screwed into the ground. This allows the end 26 of the arm 22 to be fully embedded in the hard soil.

When the eye lag screw 12 is screwed about half way into the ground, the loop of the inflatable object is looped around the end of the arm 22 so that the end of the arm 22 passes through the inflatable object loop. The eye lag screw 12 is then screwed into the ground the rest of the way until it bottoms out, and the end 26 of the arm 22 is embedded into the ground. The eye lag screw 12 bottoms out when the bottom surface of the washer stop 20 engages with the ground. The loop of the inflatable object is then captured around the arm 22 and cannot be removed therefrom until the eye lag screw 12 is withdrawn from the ground somewhat. It can be appreciated that when it is desired to remove the loop of the inflatable object from the arm 22, the eye lag screw 12 need be withdrawn from the ground only a small amount, and not all the way.

FIG. 3 illustrates the tie-down stake 10 installed so as to anchor the plastic leg 30 of an inflatable object to the ground. The bottom end 26 of arm 22 of the tie-down stake 10 passes through a hole (not shown) in the leg 30 and captures the leg 30 to the ground. When the bottom end 26 of the arm is embedded in the ground, there is no way the leg 30 can be moved until the eye lag screw 12 is at least partially withdrawn from the ground, i.e., unscrewed until the end 26 of the arm 22 is above the ground surface.

FIG. 4 illustrates the tie-down stake 10 installed in the ground, with the end 26 of the arm 22 embedded in the ground. However, in this application, the loop 32 of material of the inflatable object is looped around the eye 18 of the eye lag screw 12. Here, the eye 18 of the eye lag screw 12 provides the second anchor point of the tie-down stake 10.

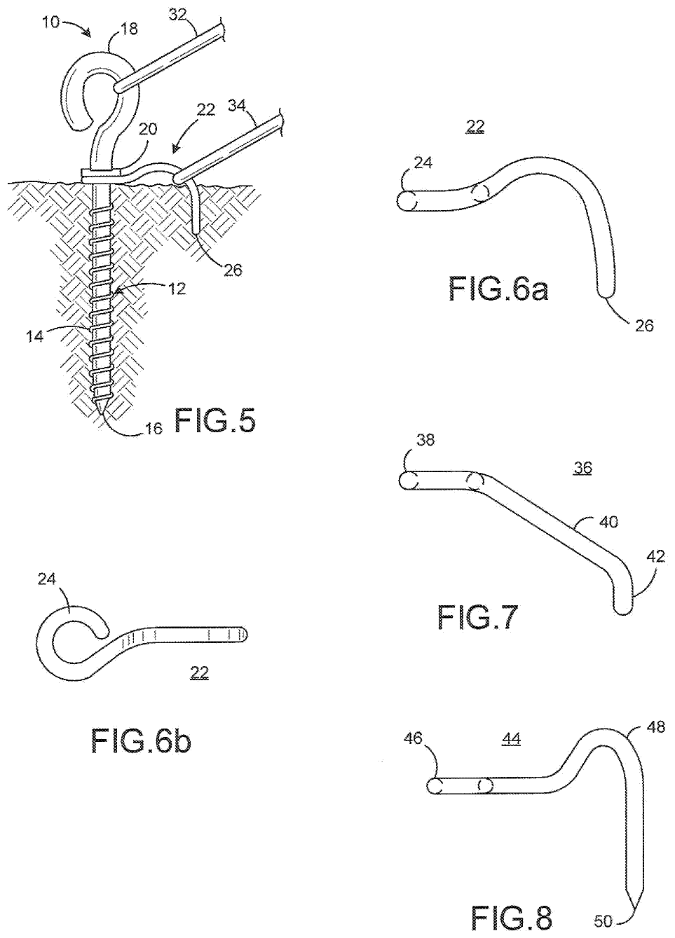

FIG. 5 illustrates the tie-down stake 10 installed in the ground in the same manner described above. However, in this application, the loop 32 of the inflatable object is anchored to the eye 18 of the eye lag screw 12, and the loop 34 of the same or a different inflatable object is anchored by the arm 22. Thus, the tie-down stake 10 can provide two different anchor points. It should be appreciated that because the arm 22 can swivel around the threaded shaft 14 of the eye lag screw 12, the tether 34 does not become twisted as the eye lag screw 12 is screwed into the ground. On the other hand, as the eye lag screw 12 is screwed into the ground, the other tether 32 may become twisted, which can function to make the tether 32 more taught.

FIG. 7 illustrates another embodiment of an arm 36 constructed according to the invention. The arm 36 is constructed with a hoop 38 through which the threaded shaft 14 of the eye lag screw 12 is inserted. The arm 36 includes a portion 40 that angles downwardly at an angle of about 45 degrees. The end of the angled portion 40 terminates in a downwardly depending portion 42 that is embedded in the ground. The angled portion 40 can be constructed with angles other than 45 degrees.

FIG. 8 illustrates another embodiment of an arm 44 constructed according to the invention. The arm 44 is constructed with a hoop 46 through which the threaded shaft 14 of the eye lag screw 12 is inserted. The arm 44 includes a portion 48 that is curved upwardly and then downwardly and terminates in a downwardly depending pointed end 50. The curved portion 48 is more pronounced than the curved portion of the arm 22 of FIG. 6a. In this embodiment of the arm 44, when the eye lag screw 12 is fully inserted in the ground, and the pointed end 50 of the arm 44 is embedded in the soil, there exists a circular portion 48 that is above the ground. The circular portion 48 is sufficiently above the ground, that it allows the user to easily string anchor cords and tethers through such portion 48 to anchor objects thereto.

While the foregoing describes the tie-down stake 10 for use in anchoring inflatable objects to the ground, the stake 10 is not limited for use with such objects. Rather, the tie-down stake 10 can be used to anchor the looped tether cords of tents, shade awnings, etc., as well. In addition, the tie-down stake 10 can be employed with tether cords that do not have loops therein. In this instance, the tether cords can be wrapped around the arm before or after the arm is embedded in the ground. Further, the arm need not be engaged with a loop of an object, but rather the end 26 of the arm can pierce fabric material to anchor the material of the object to the ground. The arm can be engaged around a support rod of an object to anchor the object to the ground. In other words, objects which have any type of apparatus that can be engaged with the arm can be anchored to the ground with the tie-down stake 10. In other applications, the user may desire to use the eye lag screw itself, without the arm, to anchor object to the ground.

The preferred embodiment of the invention is described as constructed with coarse threads, similar to a conventional lag screw. However, the principles and concepts of the invention do necessitate the use of such type of threads. The tie-down stake of the invention can be constructed and operated with other types of mechanisms to embed the stake into the ground, such auger threads as illustrated in U.S. Pat. No. D632,442; or helical threads as illustrated in U.S. Pat. No. 8,561,951. The term used herein “threads” is meant to include these mechanisms also.

While the preferred and other embodiments of the invention have been disclosed with reference to specific tie-down stake components, and associated methods of fabrication thereof, it is to be understood that many changes in detail may be made as a matter of engineering choices without departing from the spirit and scope of the invention, as defined by the appended claims.

What is claimed is:

1. A tie-down stake, comprising:
a threaded shaft having a bottom end that is pointed, said threaded shaft having a top end constructed with an eye;
an arm having a hoop through which said threaded shaft passes, said arm further including a capture member that includes a portion that extends downwardly so that when said threaded shaft is screwed into the ground, a bottom terminal end of said capture member is embedded in the ground, and a tether cord can be captured between said capture member and the ground; and
whereby said tether can be removed from said capture member without entirely removing said threaded shaft from the ground.

2. The tie-down stake of claim 1, wherein said threaded shaft has a stop located between said eye and said threaded shaft.

3. The tie-down stake of claim 1, wherein an end of said capture member is adapted for being forced into the ground when said threaded shaft is screwed into the ground.

4. The tie-down stake of claim of claim 1, wherein the hoop of said arm is constructed for rotation around the threaded shaft.

5. The tie-down stake of claim of claim 2, wherein said stop comprises a washer welded at one or more spots around said threaded shaft.

6. The tie-down stake of claim of claim 1, wherein said arm has an angled section between said hoop and a terminal end thereof, said angled section angled downwardly and laterally outwardly.

7. The tie-down stake of claim of claim 5, wherein said arm has a lateral section and a downwardly depending terminal end, and a partial circular section located between said lateral section and said downwardly depending terminal end.

8. The tie-down stake of claim 1, wherein said stake is adapted for anchoring objects using said eye as a first anchor point, and using said arm as a second anchor point.

9. The tie-down stake of claim 1, wherein said threaded shaft is constructed with one of threads shaped as threads of a lag screw, shaped as an auger, and having a helical shape.

10. A tie-down stake, comprising:
an eye lag screw having a threaded shaft with a bottom end that is pointed, said eye lag screw having a top end constructed with an eye;
said eye lag screw having a stop welded to the shaft having threads;
a swivel arm having a hoop through which said threaded shaft passes until stopped by said stop, said arm thus adapted for remaining non-rotatable while said eye lag screw is screwed into the ground, said arm further including a capture member that includes a portion that extends radially outwardly from said hoop and then downwardly so that when said eye lag screw is screwed into the ground, a bottom terminal end of said capture member is embedded in the ground, and a tether cord can be captured between said capture member and the ground; and
whereby said tether can be removed from said capture member without entirely removing said threaded shaft from the ground.

11. The tie-down stake of claim 10, wherein said arm has a lateral section and a downwardly depending terminal end, and a partial circular section located between said lateral section and said downwardly depending terminal end.

12. A method of using a tie-down stake to anchor objects, comprising:
threading a hoop of an arm over a threaded shaft of an eye lag screw so that a capture portion of said arm extends laterally outwardly and a terminal end of said arm extends downwardly;
screwing the eye lag screw partially into the ground without rotating said arm;
engaging a loop of the object to be anchored around said arm; and
screwing the eye lag screw further into the ground until the terminal end of said arm is embedded in the ground, whereby said tether is captured between said arm and the ground.

13. The method of claim 12, further including screwing the eye lag screw into the ground until the hoop of said arm is stopped by a stop and until the terminal end of said arm is embedded in the ground.
